(19) United States
(12) Patent Application Publication
(10) Pub. No.: US 2004/0048227 A1
(43) Pub. Date: Mar. 11, 2004

(54) Method and device for a dental unit or unit intended for the human body

(76) Inventor: Izidor Brajnovic, Goteborg (SE)

Correspondence Address: SWIDLER BERLIN SHEREFF FRIEDMAN, LLP, 3000 K STREET, NW, BOX IP, WASHINGTON, DC, 20007, US

(21) Appl. No.: 10/451,529

(22) PCT Filed: Dec. 27, 2001
(86) PCT No.: PCT/SE01/02897

(30) Foreign Application Priority Data
Dec. 29, 2000 (SE) 0004883-5

(51) Int. Cl. A61C 13/00; A61C 5/04

(52) U.S. Cl. 433/167; 433/89

(57) ABSTRACT

A method and a device for reinforcing a unit for dental purposes by applying matrix material via an opening in the unit. Components included in the matrix material are kept separately in two enclosed spaces, and the spaces are brought into internal contact with each other via a connecting member. Upon or after said internal contact, a mixing member situated inside the first space acts on the viscous matrix components which have been mixed toether are fed from the space to the inside of the unit via the opening, without any substantial leakage to the outside of the unit.

The present invention relates, inter alia, to a method for reinforcing a unit for dental purposes or purposes related to the human body, e.g. a replacement part in the form of a dental bridge, an assembly template for securing the dental bridge, etc., by applying viscous matrix material via an opening in the unit. The invention also relates to a device in connection with said method, and to a device for supplying means for matrix material which is viscous at least in an initial stage in the unit in said dental or human body context, where the unit comprises a shell which contains reinforcement and is intended to receive said matrix material.

Reference is made, inter alia, to Swedish Patent 457,691 which relates to a prosthetic structure of composite material with a considerable fiber content, where the matrix material, for example acrylic plastic, is injected into the fiber arrangement which is then allowed to polymerize in a mold to give the finished prosthesis blank.

The matrix material in question is hazardous to health and exposes the personnel involved to health risks. There is therefore a need to be able to design and supply the system in such a way that said risks can be largely eliminated. The main object of the present invention is to solve this problem, among others.

There is also a need to be able to design the system with relatively technically simple means and procedures, for example so that the injection can be precise. It is also important that distribution and sale can be such that the containment of the hazardous means remains effective. The invention solves this problem too.

The features which can principally be regarded as characterizing a method according to the invention are, inter alia, that components included in the matrix material and initially viscous are kept separately in two enclosed spaces, that the spaces are brought into internal contact with each other via a connecting member, and that, upon or after said internal contact, a mixing member situated inside or connected to at least the first space is acted upon so as to mix the viscous matrix components together. Further characteristics are that the mixed-together and still viscous matrix components are fed from the space or spaces to the inside of the unit via the opening, without any substantial leakage to the outside of the unit taking place.

Further developments of the inventive concept are set out in the attached dependent claims relating to the method and include, inter alia, that the first, and second enclosed spaces are arranged in two injection syringes where, for example, an epoxy base is applied in a first space formed by the barrel space of the first injection syringe, and a hardening agent is applied in the second space formed by the barrel space of the second injection syringe.

A device according to the invention can in principle be regarded as being characterized by the fact that it comprises two initially separate spaces for two initially viscous matrix material components, and that a connecting member is arranged to internally connect said spaces. Further characteristics are that at least one of the spaces has included in it, or connected to it, a mixing member which, as a function of the action or actions exerted on it, brings about mixing of the matrix material components upon or after coupling-together of the spaces, and that the device is moreover designed to permit said application to the unit without any substantial leakage to the outside of the unit.

Further developments of the novel device are set out in the attached dependent claims and include, inter alia, that the first space is to be arranged in a first injection syringe and the second space is to be arranged in a second injection syringe. In the initial state, i.e. in the uncoupled position, the first injection syringe comprises a first quantity of matrix material which for example can have the form of an epoxy base. The second space in the second injection syringe can contain a hardening agent.

A device for supplying agents in accordance with the invention can be regarded as being characterized by the fact that two space-enclosing units, e.g. two injection syringes separately contain, in their spaces, matrix material components in an initial state. Said spaces or space-enclosing units can be internally connected by means of a connecting member, and at least one space-enclosing unit is provided with a mixing member which, upon internal connection of the units or the spaces, can be actuated so as to mix the matrix material components. Further characteristics in this case are that at least the space-enclosing units or injection syringes are packed with the matrix material components separately from each other in sealed packages.

Further developments of the inventive concept are set out in the attached dependent claims.

The features which have been proposed above afford advantages in that distribution and sale can be carried out efficiently and safely. The actual injection procedure in the unit can be carried out in a well-sealed system from which substances hazardous to health are largely prevented from leaking. The injection as such is effective and it is guaranteed, for example, that the reinforcement inside the shell will be wetted completely by the mixed-together matrix material. Thus, a unit in the form of a latex tube with carbon fiber can be used. Conventional injection syringes, e.g. for 5 ml and 3 ml Araldite LY 5138, can be used. In addition, it is possible to use injection syringes for 3 ml with 0.8 ml hardening agent HY 5138. A syringe-coupling nozzle in accordance with what is described below can be used. The package in question also includes protective gloves, mouth protector and instructions concerning the mixing procedure.

A presently proposed method and a presently proposed device having the characteristic features of the invention will be described below with reference to the attached drawings, in which:

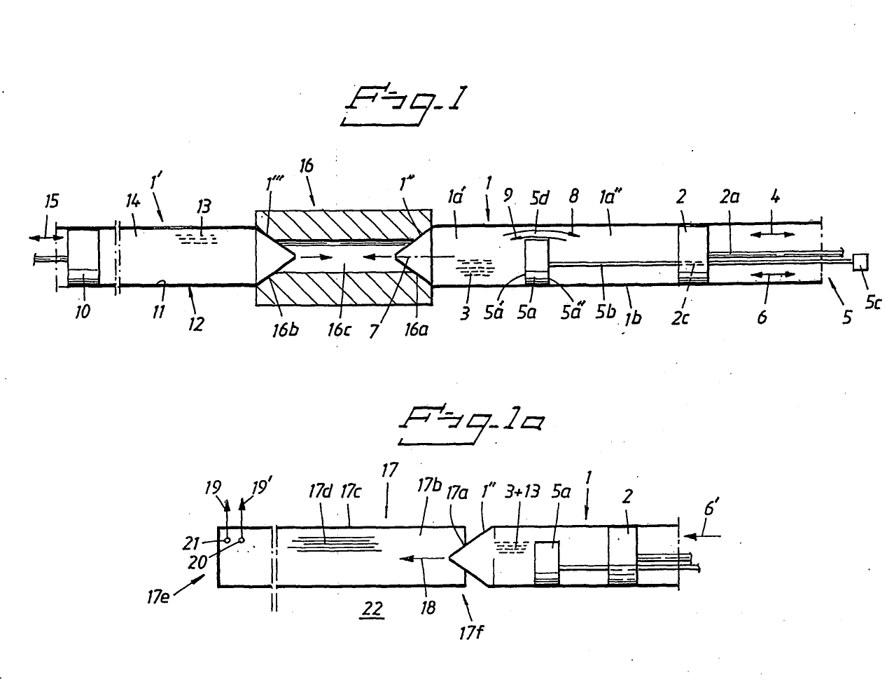

FIG. 1 is a cutaway and diagrammatic side view showing how a coupling member couples together two spaces included in injection syringes which contain matrix material components,

FIG. 1a is a cutaway and diagrammatic side view showing the injection of mixed-together matrix material components into a dental unit or unit intended for the human body,

FIG. 1b is a side view showing a design embodiment of the syringe-coupling nozzle which is used in the embodiment according to FIG. 1,

FIG. 1c is a side view showing a design embodiment of the structure according to FIGS. 1 and 1b,

FIG. 1d is a side view showing a design embodiment of the connection of the first syringe to the unit,

FIG. 1e is a side view and cutaway view showing the connection of the first syringe to the unit according to FIG. 1d,

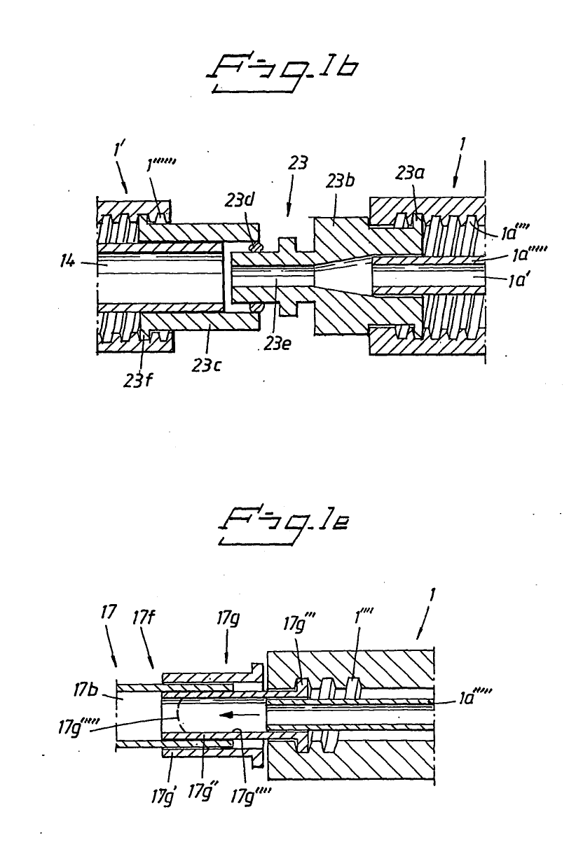

FIG. 2 is a side view showing a first injection syringe which contains a first matrix material component, e.g. an epoxy base,

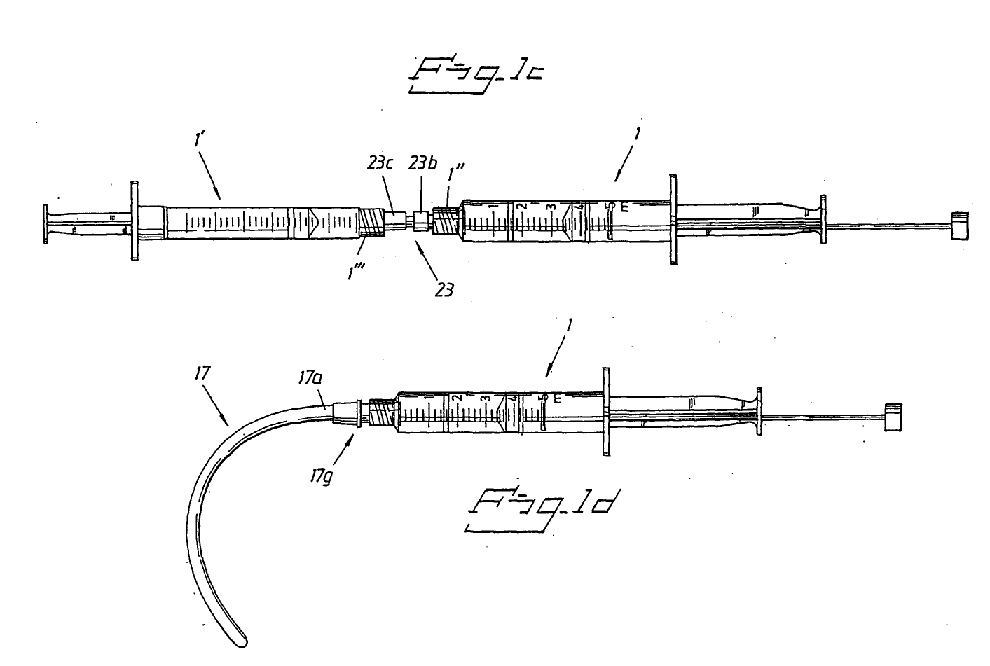

FIG. 3 is a side view showing a second injection syringe with a second matrix material, e.g. in the form of a hardening agent,

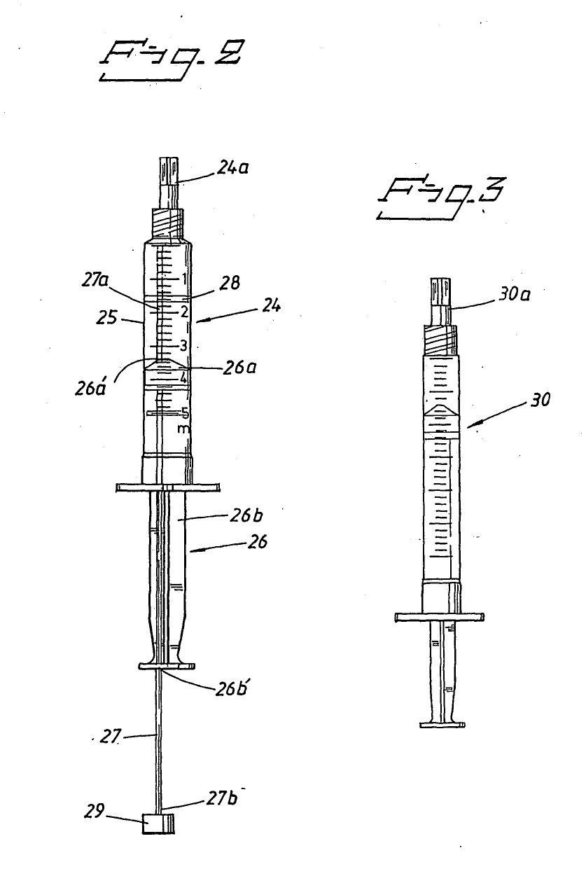

FIG. 4 is a side view showing the packaging of the injection syringes shown in FIGS. 2 and 3, together with protective gloves, mouth protector and instructions,

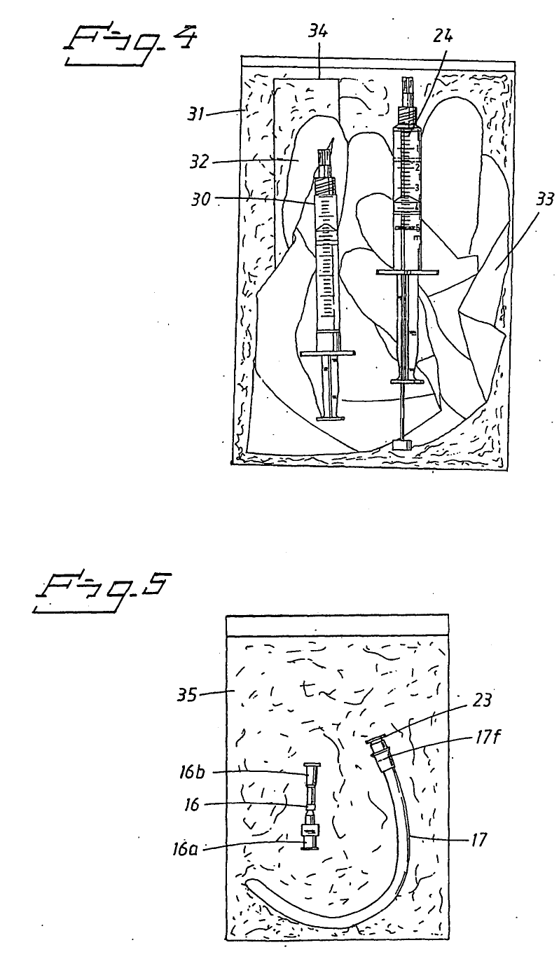

FIG. 5 is a horizontal view showing a carbon fiber-reinforced unit with associated nozzle for injection in the unit, and the coupling nozzle for the injection syringes according to FIGS. 2, 3 and 4, and

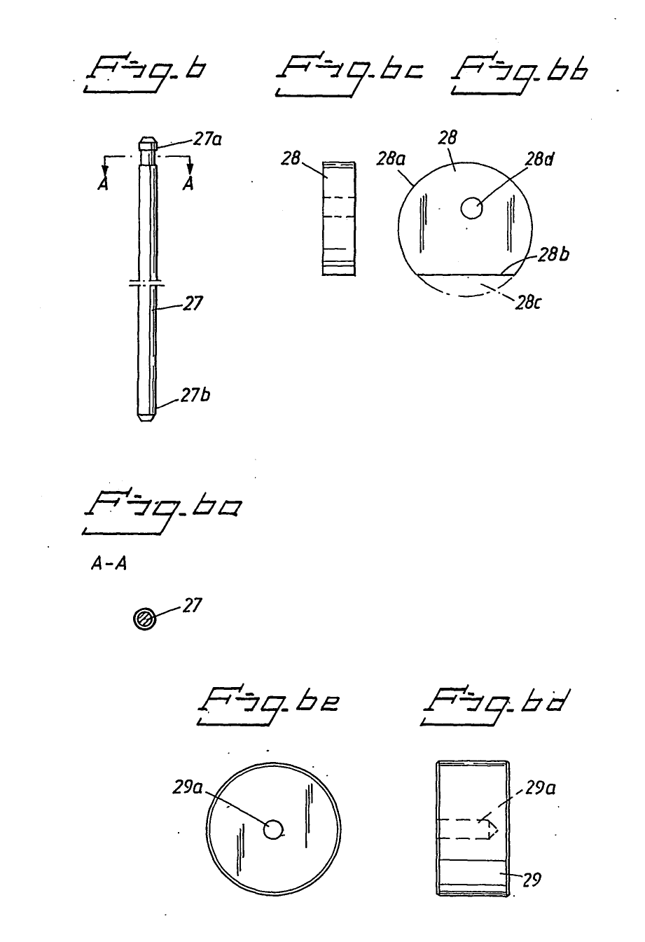

FIGS. 6 to 6e are various views showing a design embodiment of a mixing member which can be applied in the injection syringe according to FIG. 2.

In FIG. 1, a first injection syringe is indicated diagrammatically by 1, and a second injection syringe is indicated diagrammatically by 1′. The injection syringes can in principle have conventional structures, but with the exception that the injection syringe 1 has been provided with a special mixing member. The injection syringe 1 has a space which is made up of two subsidiary spaces 1a′ and 1a″. The plunger of the injection syringe is indicated by 2, which plunger can be made of rubber or other elastic material. A first matrix material component symbolized by 3 is contained in the spaces 1a′ and 1a″. In this illustrative embodiment, the matrix material component 3 can consist of Araldite LY 5138. The total space in the cylinder-shaped part 1b of the syringe 1 can be varied in a manner known per se with the aid of the plunger 2 which can be acted upon in the directions of the arrows 4 by acting on the plunger rod 2a in a manner known per se. Said mixing member comprises a first part 5a and, connected to this, a second part 5b. The mixing member as such has the reference label 5. At one end, the part 5b is provided with a part 5c which is shaped as a handle or actuating part. The part 5b extends through a recess 2c in the plunger 2. The mixing member, i.e. the parts 5a and 5b, is displaceable in the longitudinal direction of the injection syringe, i.e. along the center axis 7 of the injection syringe. The directions of displacement are indicated by the arrows 6 in FIG. 1. Upon the relative displacement of the mixing member 5a, 5b, 5c, the part 5a moves relative to the barrel wall 1b and the plunger 2. The first part 5a is also provided with a continuous recess 5d via which the matrix material component 3 can pass in the directions of the arrows 8 and 9 as a function of the actuation directions 6. Upon the relative displacement of the first part, the matrix material component is displaced between the upper and lower sides 5a′ and 5a″, respectively, of the first part. The displacement of the matrix material component 3 takes place in the directions of the arrows 8 and 9 as a function of the actuation directions 6.

The second injection syringe 1′ is also provided with a plunger 10, for example made of rubber material or other elastic material which seals against the inner wall 11 of the cylindrical part 12 of the injection syringe. In the present case, a second matrix material component 13, for example in the form of a hardening agent HY 5138, is introduced into the inner space of the syringe, indicated by 14 in FIG. 1. The directions of movement of the plunger 12 are shown by the arrows 15.

A syringe-coupling nozzle is indicated by 16. The nozzle has two bearing seats 16a and 16b for the injection syringes 1 and 1′. The nozzle 16 is in this case designed in such a way that, upon application of the injection syringes to the nozzle (or vice versa), an open inner channel 16c is present. Upon insertion of the front parts 1″ and 1′″ in the nozzle 16, the connections between the inner spaces 1a′, 1a″ and 14, respectively, in the syringes are opened to the open channel 16c, which thus means that the inner spaces in the syringes come into connection with each other, which also applies to the matrix material components 3 and 13, respectively, contained in the syringes. By acting on or pressing the plunger 2 to the right in the figure and by acting on or pressing the plunger 10 to the right in the figure, the matrix material component 13 can be made to leave the syringe 1′ and is transferred to the spaces 1a′, 1a″ in the syringe 1. After the transfer of the matrix material component 13 in the spaces 1a′, 1a″, the mixing member 5, 5a, 5b, 5c can be acted upon for the abovementioned relative movement, which means that a mixing function (cf. the arrows 8 and 9) of the matrix material components 3 and 13 occurs in the space 1a′, 1a″. The matrix material components thus mixed together can be returned in part to the space 14 by means of acting on or pressing the plungers 2 and 10 to the left in the figure. By means of such a procedure, any residues of hardening agent, i.e. the matrix material component 13, can be taken up by the mixed-together matrix material components. In one embodiment, a complete mixing-together of the matrix material components 3 and 13 can be considered to be obtained, for example, after ten full strokes for the part 5a in the spaces 1a′, 1a″.

When the matrix material components 3 and 13 have finally been mixed together and are situated in the spaces 1a′ and 1a″, the injection syringe 1 can be removed from the syringe-coupling nozzle 16 (or vice versa) and transferred to the unit 17 which is provided with an opening 17a which leads to the inside 17b of the unit, which is located inside a shell 17c. The direction of application for the syringe 1 relative to the unit 17 is indicated by 18 in FIG. 1a. In its inside 17b, the unit is provided with carbon fiber reinforcement 17d in accordance with what is described below. By pressing the plunger 2 in the direction of the arrow 6′, i.e. to the left in the figure, the mixed-together matrix material 3+13 can be injected into the inside 17b of the unit in the direction of the arrow 18. In connection with the injection, any air 19, 19′ enclosed inside the shell 17c of the unit can pass out through air removal holes 20, 21 at the end 17e of the unit, which is the opposite end in relation to the end 17f at which injection of the mixed-together matrix material takes place. The sealing function between the front parts 1″ of the syringe 1 and the opening 17a in the unit 17 is here assumed to be such as to prevent at least any substantial leakage of matrix material to the outside 22 of the unit 17, i.e. to the surrounding atmosphere. When the plunger 2 is acted upon according to FIG. 1a, there does not need to be any relative displacement of the part 5a, as the latter can be freely controlled by the present injection procedure.

FIG. 1b shows the connection of the front parts of the first and second syringes 1″ and 1′″, respectively, to a nozzle 23 (cf. 16 in FIG. 1) which can be engaged on the syringes (or vice versa) so that the inner spaces 1a′ and 14, respectively, of the syringes are connected to one another. The nozzle is designed to guarantee said substantial leaktightness upon internal transfer of material/substance in the syringes. The syringe 1 is provided with an internal thread or bayonet socket 1a″″, by means of which the syringe can be screwed onto the nozzle 23 (or vice versa) by means of a flange 23a on the latter. The syringe also has a guide pin 1′″″ by means of which the syringe is guided relative to the nozzle. The nozzle consists in principle of two parts 23b and 23c sealed off and secured by means (adhesive) 23d. The part 23b has an inner channel 23e for transporting substance between the inner spaces of the syringes. The front parts of the second syringe are also provided with a bayonet socket or internal thread 1″″″, in which the second syringe can be screwed via a flange 23f on the nozzle. Before being secured or screwed onto the nozzle, the syringes are provided with plug-shaped parts which enclose the syringes' substances before use. The plug-shaped parts are removable.

FIG 1c shows a practical illustrative embodiment of the nozzle structure and the connection of the first and second syringes 1 and 1′, respectively, to the nozzle 23. Here, the first syringe 1 is connected to the nozzle part 23b, and the second syringe 1′ is connected to the second part 23c of the nozzle. The front parts 1″ and 1′″ of the syringes are, in accordance with the above, provided with internal threads via which the syringes can be screwed into the syringe-coupling nozzle 23 (cf. also 16 in FIG. 1).

FIGS. 1d and 1e show in a corresponding manner the connection of the first syringe 1 to the unit 17 (cf. also FIG. 1a). In this case, a connecting member 17g is used which is arranged at the front parts 17a of the unit 17. The connecting member comprises an outer clamping sleeve 17g′ and a sleeve-shaped part 17g″ which at its outer end is provided with a flange 17g′″. The sleeves clamp the shell (tube) of the unit 17 between them. The first syringe 1 can be screwed onto said flange 17g′″ with the aid of its internal thread 1″″. The guide part or guide tube 1a′″″ of the syringe is guided in the inner wall 17g″″ of the part 17g″. An internal channel is established in this way and media can be transferred in accordance with the above from the inside of the syringe to the inner space 17b of the unit 17. The inner sleeve 17g″ can be arranged with a symbolically indicated plug or wall part 17g′″″ which during use, i.e. during injection of the substance in the syringe 1 into the unit, prevents contact between the syringe and the space in the unit. The plug-shaped or wall-shaped part can in this case be punctured in a manner known per se. Such a wall part can be used in cases where the unit encloses liquid medium before the substance in the syringe is to be introduced.

As regards the unit 17, in one illustrative embodiment it consists of a latex tube which can be blue in color and can be shaped as a dental arch or part of a dental arch or a dental arch template. One end 17e is closed off except for said small hole for removing air in conjunction with wetting of the carbon fiber. According to FIG. 1b, at the other end 17f of the unit there is an opening, e.g. in an attached nozzle 23 (see FIG. 1b) for application to the syringe with the matrix material. The wall of the latex tube can be, for example, 0.3 mm thick, and in connection with its use in the dental field must be pierced with one or more perforating tips. The latex tube holds the carbon fiber and matrix in place, so that the matrix for example does not run out. With the aid of silicone castings which are mounted on the outside of the latex tube or of the finished plastic model or of the template, a desired shape can be obtained in accordance with a given dental arch shape. In addition, with the aid of silicone castings, it is possible to mount mechanical retainers or brackets for individual teeth in the carbon fiber-reinforced dental bridge when the latex tube is used for this purpose. The carbon fiber can consist, for example, of five sections of hoses, which. each consist of 48 rovings, braided with each other in the form of a tube. Each roving consists of ca. 6000 fibers. The hoses are fitted into each other. In this way a total of 240 rovings are formed, with ca. 6000 fibers in each, i.e. a total of ca. 1,440,000 fibers. The fibers are treated in the production process in such a way that the matrix is optimally secured to the fiber. This can be done in a manner known per se.

According to FIG. 2, the first injection syringe is a syringe having the same basic configuration as the syringe which is commercially available on the open market under the name Becton Dickinson EDC B9140 Temse, BD 5 ml Syringe Luer-LOK™, which is adapted according to the invention in order to mix epoxy base and hardening agent in a closed system. The adaptation can involve the plunger of the injection syringe being removed from the syringe casing and the rubber washer (plunger) being disassembled. A 2-mm hole is drilled near the center of the plunger along its length, so that the result is a hole through the rubber washer and at the end of the plunger. The rubber washer (plunger) is provided with a hole using, for example, a ca. 1-mm cannula to obtain a round hole. In FIG. 2, the injection syringe is indicated by 24, and the barrel part by 25, and the plunger part by 26b. The plunger part has a rubber part 26a arranged in the barrel 25, and an outer actuating part 26b. In FIG. 2, the hole in the plunger part 26a is indicated by 26a′ and the hole on the actuating part 26b is indicated by 26b′. In addition, the plunger has front parts 26c and 26d which constitute bearing parts for the plunger and support parts for the rubber seal 26a, in which continuous holes 26c′ and 26d′ are arranged.

A metal wire or metal rod 27, e.g. of stainless steel or brass, and for example with a diameter of 2 mm, is mounted in said holes 26a′, 26b′, 26c′ and 26d′. The inner end 27a of the wire or rod 27 is connected to a disk-shaped member 28 (cf. 5a above) inside the barrel-shaped part 25 of the syringe. The other end 27b of the rod 27 is connected to an actuating part 29 (cf. 5c above). Since the hole in the plunger part 26a is less than the diameter of the wire or rod 27, sealing is obtained between the plunger 26a and the wire or rod 27. The wire or rod 27 is arranged displaceably in said holes 26a′ and 26b′. This means that the part 28 can be imparted said relative movements in relation to the syringe barrel and plunger part 26. In one embodiment, said part can have the form of a round washer which fits in the syringe's casing or barrel-shaped space. The washer 28 can in this case be cut in from one side and in this way form a three-quarter moon so that the plastic (the matrix material) can easily flow past into the syringe or into its inner space (cf. the arrows 8 and 9 in FIG. 1). The cut-in part can have the form of a sector or a segment. A hole of suitable diameter is also formed in the washer, in the same area as the rubber plunger so that the washer can be mounted on-the wire or rod immediately after its tip. The metal wire or metal rod 27 is pushed through the rubber plunger, the tip of the syringe plunger along the center of the plunger and out through the rear side of the syringe plunger. In one embodiment, the handle part 29 is designed as a round or cylindrical plastic piece, e.g. of acrylic with a length of ca. 5 mm. An expediently blind hole is formed in the center of the plastic piece.

When the plunger has been modified in this way, it is inserted back into the syringe casing or barrel volume and is placed at the rear areas of the syringe so that the actuating forces can be imparted to the metal wire or metal rod to permit backward and forward movements of the washer 28 in the syringe.

The modified injection syringe according to FIG. 2 is charged with 3 mm of Araldite LY 5138 which is a construction adhesive intended to be mixed with 0.8 ml of hardening agent HY 5138. When the injection syringe according to FIG. 2 has been charged, the syringe is closed using a modified cannula nozzle which is screwed onto the top of the syringe formed by a LUER-LOK™. The part which can be screwed on and off is indicated by 24a and has a flange-shaped part which can cooperate with an internal thread in accordance with the above.

The injection syringe 30 according to FIG. 3 consists of a conventional injection syringe for 3 ml. In the present illustrative embodiment, this syringe does not need to be adapted and instead can be charged with 0.8 ml of hardening agent HY 5138 and then closed off using a modified cannula nozzle which is screwed onto the top of the syringe which is a LUER-LOK™. The closure part which can be screwed on and off is indicated by 30a and, like the part 28a on the syringe 28, prevents substance or material from leaking out before the particular syringe is used.

FIG. 4 shows a packaging 31 of two syringes 24 and 30 (cf. above). The syringes are charged with matrix material components in accordance with the above. The packaging 31 has a bag shape and is made for example of plastic which securely protects the syringes with their associated matrix material components. Together with the syringes, the packaging also contains protective gloves 32, a mouth protector 33 and, if appropriate, instructions 34 for handling and managing the system.

FIG. 5 shows a second packaging 35 in the form of a plastic bag which securely encloses the parts included in the package. In this case, the unit 17 is applied in the package. The aforementioned nozzle 17g is applied on the unit 17, at the end 17f of said unit. The package also contains the syringe-coupling nozzle 23 which comprises two cannula nozzles 23b and 23c with LUER-LOK™ sockets, for example a bayonet socket. With the aid of the syringe-coupling nozzle, said two injection syringes can be coupled together in accordance with the above in order to permit transfer of the plastic, hardening agent and base from one syringe into the other, and vice versa, in a closed system. The abovementioned protective gloves can be made of latex, large in size, for example laboratory gloves from the Swedish LABFAB or equivalent, and they must be used when working on unhardened plastic. Said mouth protector is used to cover the nose and mouth and must be used to reduce inhalation of vapors and particles when working with the plastic.

The abovementioned equipment is used as follows. The closures 28a, 30a for the injection syringes are loosened and the syringes are coupled together with the aid of the syringe-coupling nozzle in accordance with the above. The content of the syringe with hardening agent HY 5138 is injected across to the syringe with the Araldite LY 5138 and mixed with the aid of the mixing arrangement or mixing member which is mounted in the injection syringe according to FIG. 2. The mixing arrangement or the mixing member is driven ca. five times out and in relative to the other parts of the syringe, the result of which is that the base and the hardening agent are mixed efficiently. Thereafter, some of the mixed plastic is injected back to the syringe according to FIG. 3 and back again to the syringe according to FIG. 2, for the purpose of taking up any residues of unmixed hardening agent in the syringe according to FIG. 3. Thereafter, the mixing member can be acted upon, for example with ten complete strokes, out of and into the syringe for final mixing-together of base and hardening agent. Thereafter, the syringe according to FIG. 2 is loosened from the syringe-coupling nozzle and is connected to the carbon fiber arrangement. In connection with the injection of the matrix in the syringe into the unit, the injection can be delayed several minutes so that the air bubbles have time to escape from the mixed matrix or plastic. Thereafter, wetting of the carbon fibers can be initiated by means of the matrix being slowly pressed into the latex tube. During wetting of the carbon fibre arrangement in the latex tube, said carbon fiber arrangement can remain in the plastic package while at the same time the free end of the latex tube is directed upward in order to facilitate the abovementioned evacuation of air. When media reach the end 17e of the latex tube, some of the matrix can run out in order to ensure that all the air inside the unit is evacuated. By keeping the latex tube in the plastic bag, the plastic formation remains in the bag where it polymerizes and constitutes little risk to the environment. The total working time for the mixed matrix at room temperature is at least 20 minutes. Thereafter, production of the carbon fiber-reinforced bridge can proceed.

FIGS. 6a to 6e show the structure of the mixing member. The extent of the part 27 of the mixing member with associated end formations 27a and 27b is shown. The part 28 is designed with an arc shape 28a which merges into a segment-shaped part 28b. The removed segment is symbolized by 28c in FIG. 6b and thus constitutes the passage via which the matrix passes between the spaces 1a′ and 1a″ in FIG. 1 between the upper and lower sides of the part 5a (i.e. part 28). The eccentric hole 28d constitutes the abovementioned hole for securing the rod end 27a, the rod-end diameter and the hole 28d being designed for mutual press-fit. In FIGS. 6e and 6d, the blind recess is indicated by 29a. The rod-end diameter 27b and the hole diameter in the recess 29a are designed for a press-fit so that there is fixing between the rod and the part 29 similar to the fixing between the rod end 27a and the hole 28d.

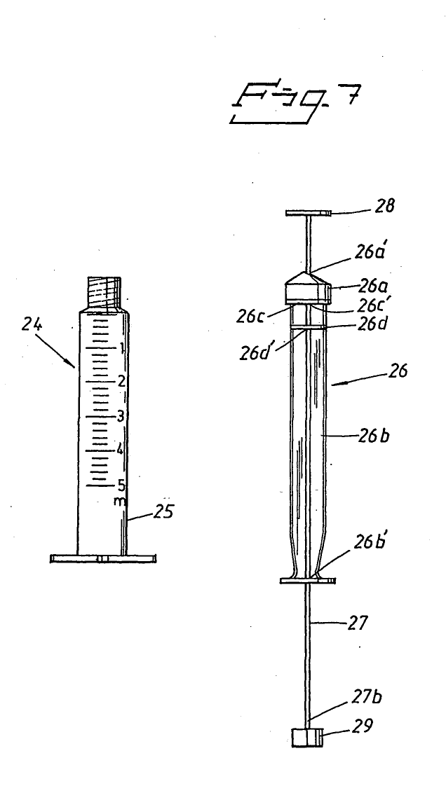

FIG. 7 shows the first syringe according to FIG. 2 in the separated state. The design of the plunger part 26 can be seen here. In the present illustrative embodiment, a rubber ring or rubber seal 26a is included, and two support flanges which are indicated by 26c′ and 26d′. Said flanges serve as bearing flanges in the barrel 25, the front support flange 26c′ also constituting a support for the rubber seal or the rubber ring 26a. A continuous hole for the rod or wire 27 is indicated by 26a′ (in the rubber ring), 26b′ (in the rear flange of the plunger), 26c′ and 26d′ in said flanges 26c and 26d. The figure also shows the actuating part 29 and the part 28 described in connection with FIG. 6.

The invention is not limited to the embodiment described above by way of example, and instead it can be modified within the scope of the attached patent claims and the inventive concept.

1. A method for reinforcing a unit (17) for dental purposes or purposes related to the human body, for example a replacement part in the form of a dental bridge, an assembly template for securing the dental bridge, etc., by applying matrix material via an opening (17a) in the unit, characterized in that components (3, 13) included in the matrix material and initially viscous are kept separately in two enclosed spaces (1a′, 1a″; 14), in that the spaces are brought into internal contact with each other via a connecting member (16), in that, upon or after said internal contact, a mixing member (5) situated inside or connected to at least the first space is acted upon so as to mix the viscous matrix components together, and in that the mixed and still viscous matrix components (3+13) are fed from the space(s) to the inside (17b) of the unit via the opening, without any substantial leakage to the outside of the unit.

2. The method as claimed in patent claim 1, characterized in that the first and second enclosed volumes (1a′, 1a″ and 14) are arranged in two injection syringes (24, 30) where an epoxy base is applied in the first space formed by the barrel space of the first injection syringe, and a hardening agent is applied in the second space formed by the barrel space of the second injection syringe (30).

3. The method as claimed in patent claim 1 or 2, characterized in that a mixing member (5) is arranged with a first part (5a) in the barrel space of the first injection syringe, and a second part (5b) which is connected to the first part and which is made to extend through the plunger (26a) of the first injection syringe, and in that the mixing member is acted upon by means of actuations of said second part (5b).

4. The method as claimed in patent claim 1, 2 or 3, characterized in that the syringes are applied to the respective ends of the connecting member (16) via their pointed areas.

5. The method as claimed in any of the preceding patent claims, characterized in that, upon actuation of the second part (5b) of the mixing member, the first part is caused to execute longitudinal displacement movements relative to the barrel space of the first injection syringe, and in that, upon said movements, the first quantity of matrix material is caused to pass through one or more continuous passages (28c) in the first part (28).

6. The method as claimed in any of the preceding patent claims, characterized in that, upon connection of the injection syringes via the connecting member (16), the second quantity of matrix material is pressed from the second injection syringe (30) into the barrel space of the first injection syringe, and in that mixing-together is thereafter carried out in the last-mentioned barrel space by means of displacement movements of the first part (5a) of the mixing member (5) relative to the barrel wall in the barrel space of the first injection syringe.

7. The method as claimed in any of the preceding patent claims, characterized in that the mixing-together is carried out by a number of full strokes, e.g. ten full strokes, of the first part (5a) of the mixing member relative to the barrel of the first injection syringe.

8. The method as claimed in any of the preceding patent claims, characterized in that, in connection with the mixing-together in the barrel space of the first injection syringe, the matrix material components which have been completely or partially mixed together are temporarily transferred completely or partially to the barrel volume of the second injection syringe in order to ensure that the mixing-together involves any residues of the second matrix material component in the barrel space of the second injection syringe, after which renewed full strokes are executed in the first injection syringe.

9. The method as claimed in any of the preceding patent claims, characterized in that the matrix material components mixed together in the barrel space of the first injection syringe are brought via said opening (17a) to the inside of the unit by means of the first injection syringe being removed from the connecting member (16), being applied with its tip against or in the opening on the unit directly or via a nozzle (23), and being acted upon for injecting the mixed-together matrix material components into the unit.

10. The method as claimed in any of the preceding patent claims, characterized in that, in connection with the injection of the mixed-together material, any air enclosed in the unit is caused to pass out to the outside (22) of the unit via one or more small holes at the end of the unit (17) away from the injection end.

11. The method as claimed in any of the preceding patent claims, characterized in that the unit is designed as a dental arch or dental arch part.

12. A device for applying viscous matrix material into a unit for dental purposes or purposes related to the human body, where the unit comprises a shell (17) provided with an opening and intended to contain reinforcement and said matrix material, characterized in that it comprises two initially separate spaces for two initially viscous matrix material components (3, 13), in that a connecting member (16) is arranged to internally connect said spaces, in that at least one of the spaces has included in it, or connected to it, a mixing member (5) which, as a function of the action exerted on it, brings about mixing of the matrix material components upon or after coupling-together of the spaces, and in that the device is designed to permit said application without any substantial leakage to the outside of the unit.

13. The device as claimed in patent claim. 12, characterized in that the first space is arranged in a first injection syringe whose internal space, here called the first space, contains a first quantity of matrix material, e.g. in the form of an epoxy base.

14. The device as claimed in patent claim 11 or 12, characterized in that the second space is arranged in a second injection syringe (30) whose internal space, here called the second space, contains a hardening agent.

15. The device as claimed in patent claim 13 or 14, characterized in that the first injection syringe is provided with barrel and plunger parts and with a mixing member (5) which can be displaced relative to the plunger and the barrel.

16. The device as claimed in patent claim 15, characterized in that the displaceable mixing member comprises a first part (5a) which is situated in the barrel and can cooperate with the first quantity of matrix component, and a second part (5b) which is connected to the first part (5a) and which extends in the plunger of the first injection syringe and can be acted upon from the outside of the first injection syringe in order to impart the relative movements of the first part (5a) relative to said barrel.

17. The device as claimed in patent claim 15 or 16, characterized in that the first part is arranged with one or more continuous passages, via which passage or passages the first quantity of matrix material passes completely or partially upon said actuation of the second part (5b).

18. The device as claimed in patent claim 17, characterized in that the first part forms a disk-shaped element from which a sector-shaped or segment-shaped part is removed to form a continuous passage.

19. The device as claimed in any of patent claims 16-18, characterized in that the first end of the second part is secured to the first part via a blind recess in the latter.

20. The device as claimed in any of patent claims 16-19, characterized in that a handle part (5c) is secured to the second part, via the second end thereof, which handle part (5c) is provided with a blind recess in which said second part extends.

21. The device as claimed in any of patent claims 12-20, characterized in that the unit is designed with one or more air passage holes for any enclosed air in connection with the application of mixed-together matrix material components.

22. The device as claimed in any of patent claims 12-21, characterized in that the unit has the form of a dental arch.

23. A device for supplying agents for producing a unit for dental purposes or purposes related to the human body, where the unit comprises a shell which contains reinforcement and is to be provided with matrix material (3+13), characterized by two space-enclosing units, e.g. two injection syringes (24, 30) which, in their spaces, separately contain matrix material components (3, 13), e.g. epoxy base (Araldite LY 1538) and hardening agent (HY 5138), a connecting member (16) which permits internal connection of said spaces or space-enclosing units, a mixing member (5) in at least one space-enclosing unit which, upon or after internal connection of the units or the spaces by the connecting member, permits mixing of the matrix material components as a function of actuations imparted to it, and sealed packages which contain at least the space-enclosing units or injection syringes charged with or filled with the matrix material components.

24. The device as claimed in patent claim 23, characterized in that the unit too, e.g. the carbon fiber-reinforced unit, is packed in a sealed package together with an attachment nozzle for the first injection syringe.
